(19) United States
(12) Patent Application Publication
(10) Pub. No.: US 2022/0376569 A1
(43) Pub. Date: Nov. 24, 2022

(54) ROTOR, MOTOR, FAN, AND AIR CONDITIONER

(71) Applicant: Mitsubishi Electric Corporation, Tokyo (JP)

(72) Inventors: Kazuchika TSUCHIDA, Tokyo (JP); Hiroki ASO, Tokyo (JP); Takaya SHIMOKAWA, Tokyo (JP); Ryogo TAKAHASHI, Tokyo (JP)

(21) Appl. No.: 17/789,299

(22) PCT Filed: Feb. 12, 2020
(86) PCT No.: PCT/JP2020/005361

§ 371 Date: Jun. 27, 2022

(51) Int. Cl. H02K 1/276; H02K 1/30; H02K 21/16

(52) U.S. Cl. CPC H02K 1/2766; H02K 1/30; H02K 21/16; H02K 29/03

(57) ABSTRACT

A rotor includes a rotor core having an outer circumference extending in a circumferential direction about an axis and having magnet insertion holes, and permanent magnets disposed in the magnet insertion holes. The permanent magnet constitutes a magnet magnetic pole, and a part of the rotor core constitutes a virtual magnetic pole. The width of the virtual magnetic pole in the circumferential direction is narrower than the width of the permanent magnet in the circumferential direction. The rotor core has at least one slit at the virtual magnetic pole.

### CROSS REFERENCE TO RELATED APPLICATION

This application is a U.S. national stage application of International Patent Application No. PCT/JP2020/005361 filed on Feb. 12, 2020, the disclosure of which is incorporated herein by reference.

### TECHNICAL FIELD

The present disclosure relates to a rotor, a motor, a fan, and an air conditioner.

### BACKGROUND

As a rotor of a motor, there is a consequent pole rotor that includes magnet magnetic poles constituted by permanent magnets and virtual magnetic poles constituted by a rotor core (see, for example, Patent Reference 1). The consequent pole rotor has an advantage of reducing the manufacturing cost because the number of permanent magnets of the consequent pole rotor is half that of a normal rotor.

### PATENT REFERENCE

Patent Reference 1: Japanese Patent Application Publication No. 2014-131376 (see FIG. 14)

However, since the virtual magnetic pole has no permanent magnet, magnetic flux density at the virtual magnetic pole is lower than that at the magnet magnetic pole, and the flow direction of the magnetic flux tends to fluctuate. This causes an imbalance in the magnetic flux between the magnet magnetic pole and the virtual magnetic pole, thereby causing vibration and noise.

### SUMMARY

The present disclosure is made to solve the above-described problem, and an object of the present disclosure is to reduce vibration and noise in a consequent pole rotor.

A rotor of the present disclosure includes a rotor core having an outer circumference extending in a circumferential direction about an axis and having a magnet insertion hole, and a permanent magnet disposed in the magnet insertion hole. The permanent magnet constitutes a magnet magnetic pole, and a part of the rotor core constitutes a virtual magnetic pole. The rotor core has an opening portion on the axis side with respect to the magnet insertion hole. A width of the virtual magnetic pole in a circumferential direction is narrower than a width of the permanent magnet in the circumferential direction. The rotor core has at least one slit at the virtual magnetic pole. A maximum length L3 of the at least one slit in a radial direction about the axis and a maximum length L4 of the opening portion in the radial direction satisfy L3<L4.

According to the present disclosure, since the width of the virtual magnetic pole is narrower than the width of the permanent magnet, the magnetic flux tends to be concentrated on the virtual magnetic pole, and thus a magnetic flux density at the virtual magnetic pole increases. Further, at least one slit is provided at the virtual magnetic pole, so that the direction of the magnetic flux passing through the virtual magnetic pole can be corrected. Thus, an imbalance in the magnetic flux between the magnet magnetic pole and the virtual magnetic pole can be suppressed, and vibration and noise can be reduced.

### BRIEF DESCRIPTION OF THE DRAWINGS

FIG. 1 is a sectional view illustrating a motor of a first embodiment.

FIG. 2 is a sectional view illustrating a rotor of the first embodiment.

FIG. 3 is a sectional view illustrating a rotor core and permanent magnets of the first embodiment.

FIG. 4 is a sectional view for explaining the width of a magnet magnetic pole and the width of a virtual magnetic pole in the first embodiment.

FIG. 5 is a schematic diagram illustrating magnet insertion holes and slits in the rotor core of the first embodiment.

FIG. 6 is a magnetic flux diagram illustrating simulation results of the flow of magnetic flux in the rotor of the first embodiment.

FIG. 7(A) is a graph illustrating the surface magnetic flux distribution in the rotor of the first embodiment, and FIG. 7(B) is a schematic diagram illustrating the positions of magnet magnetic poles P1 and virtual magnetic poles P2.

FIG. 8 is a schematic diagram illustrating the flow of magnetic flux exiting from the magnet magnetic pole of the rotor.

FIG. 9 is a schematic diagram illustrating the flow of magnetic flux passing through the virtual magnetic pole of the rotor.

FIG. 10 is a schematic diagram illustrating the arrangement of the slits at the virtual magnetic pole of the first embodiment.

FIG. 11 is a schematic diagram for explaining the effect of the slits at the virtual magnetic pole of the first embodiment.

FIG. 12 is a sectional view illustrating a non-consequent pole rotor.

FIG. 13 is a schematic diagram illustrating the flow of magnetic flux when a distance between the slit and an outer circumference of the rotor core is increased.

FIG. 14 is a schematic diagram illustrating the flow of magnetic flux when no opening portion is provided on an inner side of a magnet insertion hole in the radial direction.

FIG. 15 is a schematic diagram for explaining the effect of an opening portion in the first embodiment.

FIG. 16 is a schematic diagram for explaining the length of the slit in the radial direction and the length of the opening portion in the radial direction in the first embodiment.

FIG. 17 is a schematic diagram illustrating an example in which the length of the slit in the radial direction is longer than the length of the opening portion in the radial direction.

FIG. 18 is a schematic diagram for explaining the flow of magnetic flux in the example of FIG. 17.

FIG. 19 is a schematic diagram for explaining the arrangement of crimping portions in the first embodiment.

FIG. 20 is a magnetic flux diagram illustrating simulation results of the flow of magnetic flux in the motor of the first embodiment.

FIG. 21 is a sectional view illustrating a rotor of a second embodiment.

FIG. 22 is a schematic diagram for explaining the arrangement of magnet insertion holes, slits, opening portions, and crimping portions of the second embodiment.

FIG. 23 is a schematic diagram for explaining another example of crimping portions of the second embodiment.

FIG. 24(A) is a front view illustrating an air conditioner to which the motor of each embodiment is applied, and FIG. 24(B) is a sectional view illustrating an outdoor unit of the air conditioner.

### DETAILED DESCRIPTION

### First Embodiment

### (Configuration of Motor)

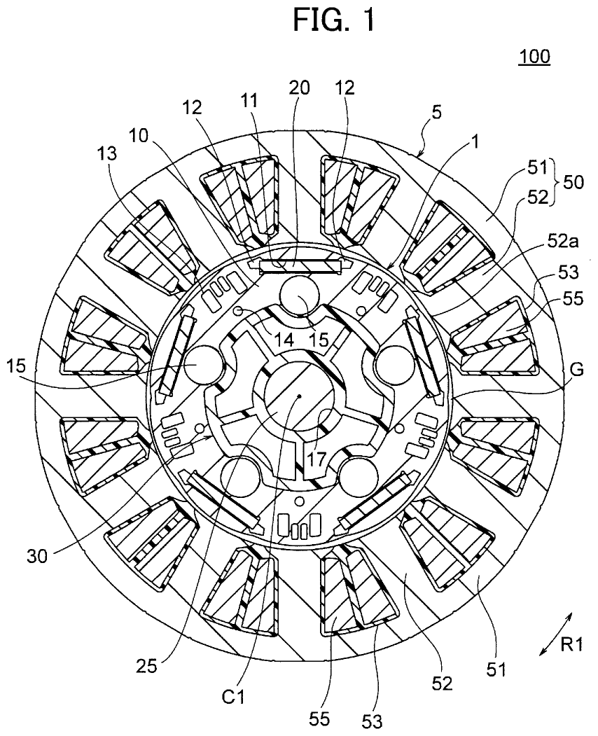

FIG. 1 is a sectional view illustrating a motor 100 of a first embodiment. The motor 100 is an inner-rotor motor, and includes a rotor 1 which is rotatable and an annular stator 5 provided to surround the rotor 1. The motor 100 is also a permanent-magnet embedded motor that has permanent magnets 20 embedded in the rotor 1. An air gap of, for example, 0.4 mm, is provided between the stator 5 and the rotor 1.

Hereinafter, the rotational central axis of the rotor 1 is referred to as an axis C1. The direction of the axis C1 is referred to as an “axial direction”. The circumferential direction about the axis C1 (indicated by an arrow R1 in FIG. 1) is referred to as a “circumferential direction”. The radial direction about the axis C1 is referred to as a “radial direction”. FIG. 1 is a sectional view of the rotor 1 in a plane orthogonal to the axis C1.

### (Configuration of Stator)

The stator 5 includes a stator core 50 and coils 55 wound on the stator core 50. The stator core 50 is formed of a plurality of electromagnetic steel sheets which are stacked in the axial direction and fixed together by crimping or the like. The sheet thickness of each electromagnetic steel sheet is, for example, 0.1 mm to 0.7 mm.

The stator core 50 has a yoke 51 having an annular shape about the axis C1 and a plurality of teeth 52 extending inward in the radial direction from the yoke 51. The teeth 52 are arranged at equal intervals in the circumferential direction. The number of teeth 52 is 12 in this example, but is not limited to 12. A slot, which is a space to accommodate the coil 55, is formed between each adjacent teeth 52.

A tip end 52a of the tooth 52 on the inner side in the radial direction has a larger width in the circumferential direction than other portions of the tooth 52. The tip end 52a of the tooth 52 faces the outer circumference of the rotor 1 via the air gap described above.

An insulator 53 serving as an insulating portion is attached to the stator core 50. The insulator 53 is interposed between the stator core 50 and the coil 55 so as to insulate the stator core 50 and the coil 55 from each other.

The insulator 53 is made of, for example, insulating resin such as polybutylene terephthalate (PBT). The insulator 53 is formed by integrally molding a resin with the stator core 50 or attaching a resin molded body, which is molded as a separate component, to the stator core 50.

The coil 55 is wound around the tooth 52 via the insulator 53. The coil 55 is made of copper or aluminum. The coil 55 may be wound around each tooth 52 (concentrated winding) or may be wound across a plurality of teeth 52 (distributed winding).

### (Configuration of Rotor)

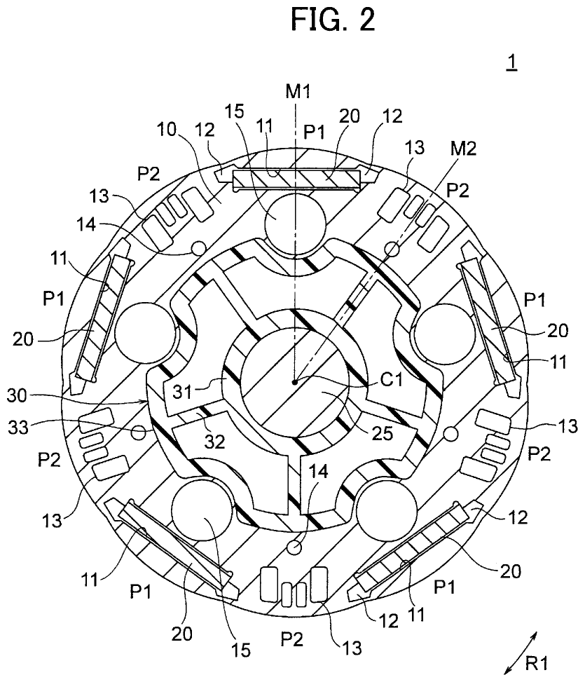

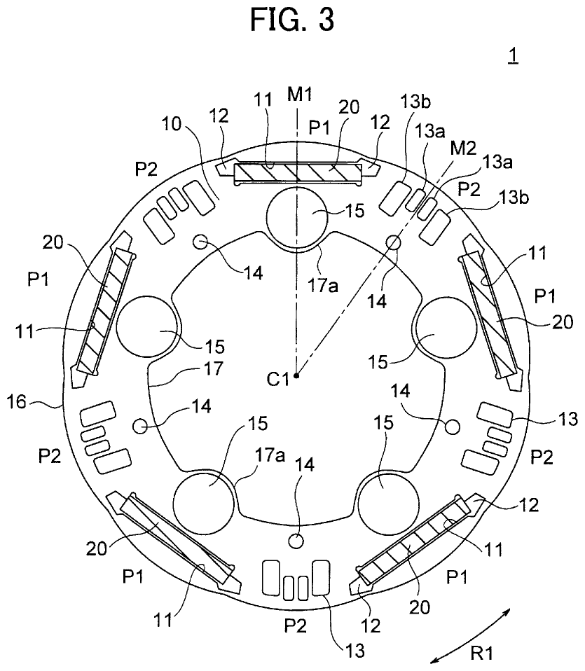

FIG. 2 is a sectional view illustrating the rotor 1. FIG. 3 is a diagram illustrating a rotor core 10 and the permanent magnets 20 in the rotor 1. As illustrated in FIG. 2, the rotor 1 includes a shaft 25 which is a rotating shaft, the rotor core 10 provided on the outer side of the shaft 25 in the radial direction, the plurality of permanent magnets 20 embedded in the rotor core 10, and a resin portion 30 provided between the shaft 25 and the rotor core 10.

As illustrated in FIG. 3, the rotor core 10 is a member that has an annular shape about the axis C1. The rotor core 10 has an outer circumference 16 and an inner circumference 17. Each of the outer and inner circumferences 16 and 17 extends in the circumferential direction about the axis C1.

The rotor core 10 is formed of a plurality of electromagnetic steel sheets which are stacked in the axial direction and fixed together by crimping portions 14. The sheet thickness of each electromagnetic steel sheet is, for example, 0.1 mm to 0.7 mm.

The rotor core 10 has a plurality of magnet insertion holes 11. The magnet insertion holes 11 are arranged at equal intervals in the circumferential direction and at equal distances from the axis C1. The number of magnet insertion holes 11 is five in this example. The magnet insertion holes 11 are formed along the outer circumference of the rotor core 10.

The magnet insertion hole 11 extends linearly in a direction orthogonal to a straight line (magnetic pole center line) that extends in the radial direction and passes through a center of the magnetic insertion hole 11 in the circumferential direction. In this regard, the magnet insertion hole 11 is not limited to such a shape, but may have a V shape, for example.

A flux barrier 12, which is an aperture, is formed at each side of the magnet insertion hole 11 in the circumferential direction. A core portion between the flux barrier 12 and the outer circumference 16 of the rotor core 10 is a thin-walled portion (also referred to as a bridge portion). The thickness of the thin-walled portion is desirably the same as the sheet thickness of each of the electromagnetic steel sheets constituting the rotor core 10 in order to suppress the leakage flux between the adjacent magnetic poles.

The permanent magnet 20 is inserted in each magnet insertion hole 11. The permanent magnet 20 has a flat plate shape, and its cross-sectional shape orthogonal to the axial direction is rectangular.

The permanent magnet 20 is composed of, for example, a rare earth magnet. More specifically, the permanent magnet 20 is composed of a neodymium sintered magnet containing Nd(neodymium)-Fe(iron)-B(boron).

Five permanent magnets 20 have the same magnetic poles (for example, N poles) on their outer sides in the radial direction. In the rotor core 10, magnetic poles (for example, S poles) opposite to the above described magnetic poles are formed in regions each between the permanent magnets 20 adjacent in the circumferential direction.

Thus, five magnet magnetic poles P1 constituted by the permanent magnets 20 and five virtual magnetic poles P2 constituted by the rotor core 10 are formed in the rotor 1. This configuration is referred to as a consequent pole type. Hereinafter, when the term “magnetic pole” is used, it indicates either of the magnet magnetic pole P1 and the virtual magnetic pole P2. In this example, the rotor 1 has 10 magnetic poles.

The center of each of the magnet magnetic poles P1 and the virtual magnetic poles P2 in the circumferential direction is a pole center. A straight line in the radial direction that passes through the pole center of the magnet magnetic pole P1 is referred to as a magnetic pole center line M1. A straight line in the radial direction that passes through the pole center of the virtual magnetic pole P2 is referred to as a magnetic pole center line M2.

The outer circumference 16 of the rotor core 10 has a so-called flower shape in a cross section orthogonal to the axial direction. More specifically, the outer circumference 16 of the rotor core 10 is shaped so that its outer diameter is maximum at the pole center of each of the magnetic poles P1 and P2 and is minimum at each pole boundary, and extends in an arc shape from the pole center to the pole boundary. The outer circumference 16 of the rotor core 10 is not limited to the flower shape, but may be a circular shape.

In the consequent pole rotor 1, the number of permanent magnets 20 can be halved as compared with a non-consequent pole rotor having the same number of poles. Since the number of permanent magnets 20 is smaller, the manufacturing cost of the rotor 1 is reduced.

Although the number of poles of the rotor 1 is 10 in this example, the number of poles only needs to be an even number greater than or equal to four. Although one permanent magnet 20 is disposed in each magnet insertion hole 11 in this example, two or more permanent magnets 20 may be disposed in each magnet insertion hole 11. The magnet magnetic pole P1 may be the S pole, and the virtual magnetic pole P2 may be the N pole.

As illustrated in FIG. 2, the non-magnetic resin portion 30 is provided between the shaft 25 and the rotor core 10. The resin portion 30 connects the shaft 25 and the rotor core 10. The resin portion 30 is made of, for example, a thermoplastic resin such as PBT.

The resin portion 30 includes an annular inner cylindrical portion 31 in contact with an outer circumference of the shaft 25, an annular outer cylindrical portion 33 in contact with the inner circumference 17 of the rotor core 10, and a plurality of ribs 32 connecting the inner cylindrical portion 31 and the outer cylindrical portion 33.

The shaft 25 penetrates in the axial direction through the inner cylindrical portion 31 of the resin portion 30. The ribs 32 are arranged at equal intervals in the circumferential direction and radially extend outward in the radial direction from the inner cylindrical portion 31. A hollow portion is formed between each two ribs 32 adjacent in the circumferential direction.

The number of ribs 32 is half the number of poles, and the position of each rib 32 in the circumferential direction is aligned with the pole center of the corresponding virtual magnetic pole P2. However, the number of ribs 32 is not limited to half the number of poles. Further, the position of the rib 32 in the circumferential direction may be aligned with the pole center of the magnet magnetic pole P1.

As illustrated in FIG. 3, the rotor core 10 has at least one slit 13 at the virtual magnetic pole P2. In this example, two slits 13a and two slits 13b are formed. The slits 13a are disposed on both sides of the magnetic pole center line M2 in the circumferential direction and the slits 13b are disposed on both sides of the slits 13a in the circumferential direction.

Both the slits 13a and 13b extend in the radial direction, more specifically in parallel with the magnetic pole center line M2. That is, each of the slits 13a and 13b has its length in the radial direction longer than its width in the circumferential direction.

The two slits 13a have the same shapes as each other and are disposed at equal distances from the magnetic pole center line M2 in the circumferential direction. Similarly, the two slits 13b have the same shapes as each other and are disposed at equal distances from the magnetic pole center line M2 in the circumferential direction. That is, four slits 13a and 13b are arranged symmetrically with respect to the magnetic pole center line M2.

The length of the slit 13a in the radial direction is shorter than the length of the slit 13b in the radial direction. The width of the slit 13a in the circumferential direction is narrower than the width of the slit 13b in the circumferential direction. The outer end of the slit 13a in the radial direction is located on the outer side in the radial direction with respect to the outer end of the slit 13b in the radial direction.

In this example, the virtual magnetic pole P2 is provided with the four slits 13a and 13b, but it is sufficient that the virtual magnetic pole P2 is provided with at least one slit 13. Hereinafter, when it is not necessary to distinguish between the slits 13a and 13b, these slits are referred to as the slits 13.

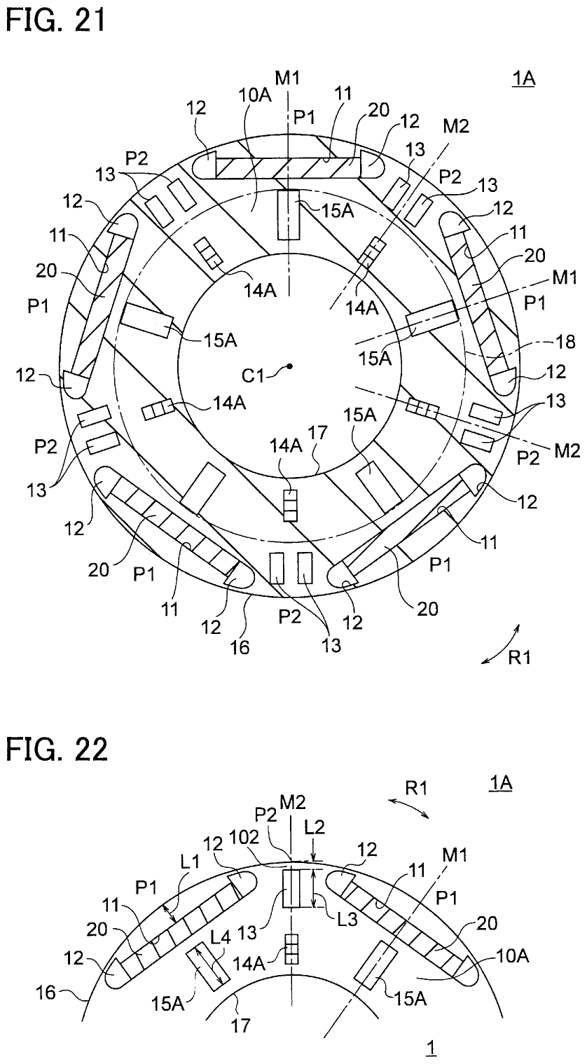

The rotor core 10 has opening portions 15 on the inner side of the magnet insertion holes 11 in the radial direction. The opening portion 15 is located on the magnetic pole center line M1 of the magnet magnetic pole P1. The opening portion 15 has a circular shape in a plane orthogonal to the axial direction. However, the shape of the opening portion 15 is not limited to the circular shape, but may have a slit shape (see FIG. 21).

On the inner circumference 17 of the rotor core 10, protruding portions 17a that protrude inward in the radial direction are formed at portions where the opening portions 15 are formed. Each protruding portion 17a on the inner circumference 17 extends in an arc shape along the inner circumference of the opening portion 15. The protruding portion 17a functions as a rotation stopper for the rotor core 10 with respect to the resin portion 30. In this regard, it is also possible that the inner circumference 17 is not provided with such protruding portions 17a.

The crimping portions 14 are provided for integrally fixing the plurality of electromagnetic steel sheets that constitute the rotor core 10. Each crimping portion 14 is desirably formed on the magnetic pole center line M2 of the virtual magnetic pole P2 and on the inner side in the radial direction with respect to the slits 13. In this regard, the crimping portion 14 may be formed in other portions.

The crimping portion 14 has a circular shape in a plane orthogonal to the axial direction. In other words, the crimping portion 14 is a circular crimping portion. In this regard, the shape of the crimping portion 14 is not limited to a circular shape, but may be a rectangular shape. In other words, the crimping portion 14 may be a V-shaped crimping portion (see FIG. 21).

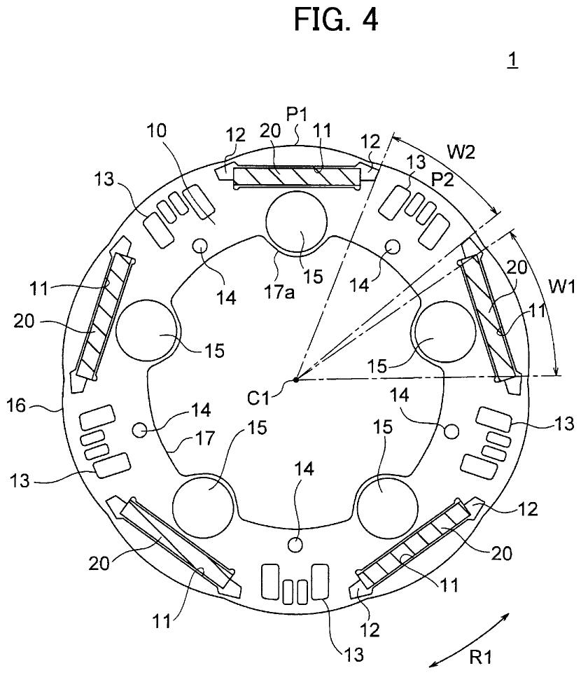

FIG. 4 is a sectional view for explaining the width of the permanent magnet 20 in the circumferential direction and the width of the virtual magnetic pole P2 in the circumferential direction. In this example, a width W1 of the permanent magnet 20 in the circumferential direction is a length in the circumferential direction of the outer surface of the permanent magnet 20 in the radial direction (a distance from one end to the other end of the outer surface in the circumferential direction).

A width W2 of the virtual magnetic pole P2 in the circumferential direction is a distance from the flux barrier 12 located on one side of the virtual magnetic pole P2 in the circumferential direction to the flux barrier 12 located on the other side of the virtual magnetic pole P2 in the circumferential direction.

The width W2 of the virtual magnetic pole P2 in the circumferential direction is narrower than the width W1 of the permanent magnet 20 in the circumferential direction. That is, W2<W1 is satisfied.

When the width W2 of the virtual magnetic pole P2 is set narrower than the width W1 of the permanent magnet 20, much magnetic flux exiting from the permanent magnet 20 passes through the narrow virtual magnetic pole P2, and thus the magnetic flux density at the virtual magnetic pole P2 increases. That is, a reduction in the magnetic flux density caused by absence of a permanent magnet at the virtual magnetic pole P2 can be compensated by narrowing the width W2 of the virtual magnetic pole P2.

In this regard, the widths W1 and W2 are not limited to the widths in the circumferential direction. Specifically, the width W1 of the permanent magnet 20 may be defined as the width in the direction orthogonal to the magnetic pole center line M1 (FIG. 3), and the width W2 of the virtual magnetic pole P2 may be defined as the width in the direction orthogonal to the magnetic pole center line M2 (FIG. 3). Also in this case, W2<W1 is satisfied.

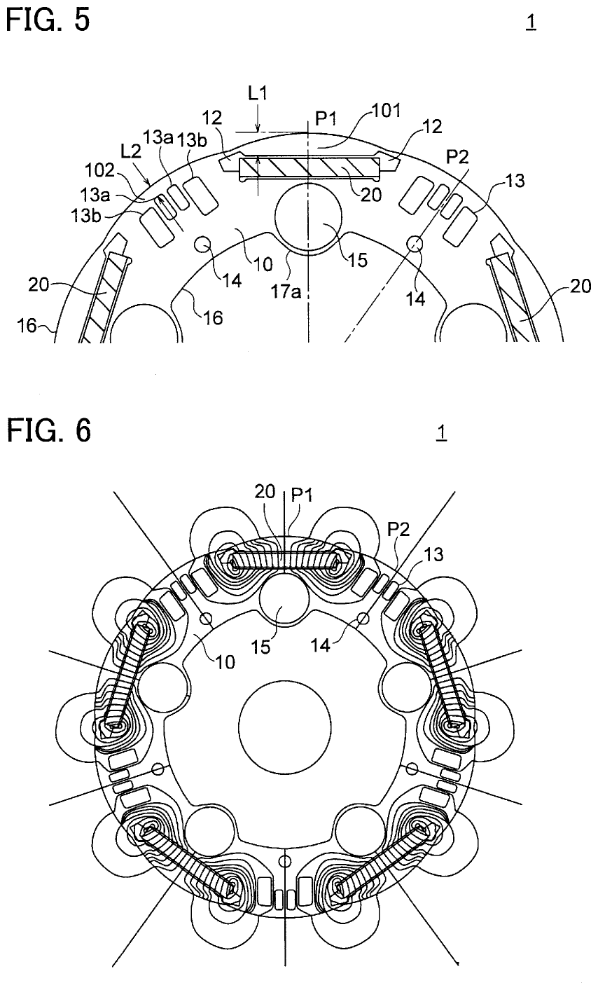

FIG. 5 is a schematic diagram illustrating the arrangement of the magnet insertion holes 11 and the slits 13 in the rotor core 10. A distance L1 from the magnet insertion hole 11 at the pole center to the outer circumference 16 of the rotor core 10 is longer than a shortest distance L2 from the slit 13 to the outer circumference 16 of the rotor core 10. Of the slits 13a and 13b in this example, the slit 13a is located closer to the outer circumference 16. The shortest distance L2 is a distance from the slit 13a to the outer circumference 16 of the rotor core 10.

### (Functions)

Next, the functions of the first embodiment will be described. FIG. 6 is a magnetic flux diagram illustrating simulation results of the flow of magnetic flux in the rotor 1.

As illustrated in FIG. 6, the magnetic flux exiting from the permanent magnet 20 at the magnet magnetic pole P1 spreads symmetrically with respect to the magnetic pole center line M1. This magnetic flux passes through the adjacent virtual magnetic pole P2 in the radial direction and returns to the permanent magnet 20 at the magnet magnetic pole P1.

The magnetic flux exiting from the permanent magnet 20 passes through the virtual magnetic pole P2. Thus, by narrowing the width W2 of the virtual magnetic pole P2 as compared to the width W1 of the permanent magnet 20, the magnetic flux is concentrated on the virtual magnetic pole P2, and a magnetic flux density at the virtual magnetic pole P2 increases.

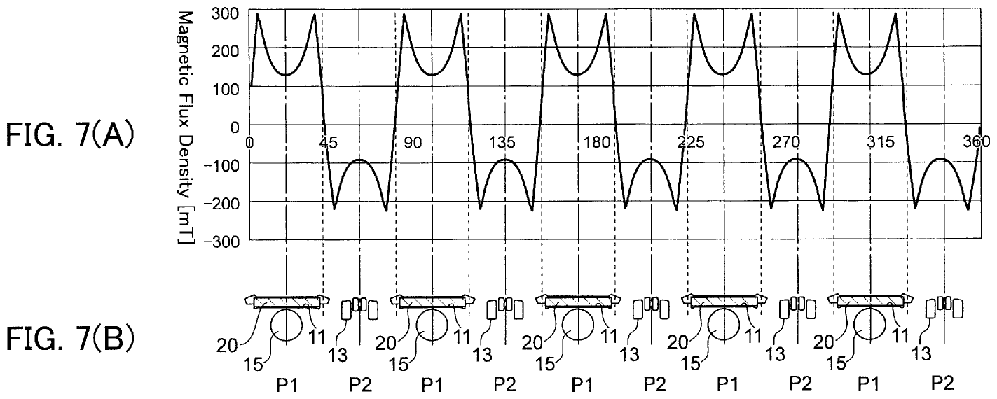

FIG. 7(A) is a graph illustrating the magnetic flux density distribution at the outer circumference of the rotor 1, obtained by actual measurement of the magnetic flux density. The vertical axis indicates the magnetic flux density [mT], while the horizontal axis indicates the position in the circumferential direction, i.e., an angle [degrees] about the axis C1.

FIG. 7(B) is a schematic diagram illustrating the positions of the magnet magnetic poles P1 and the virtual magnetic poles P2, corresponding to the magnetic flux density distribution in FIG. 7(A).

In FIG. 7(A), the magnetic flux density (i.e., the surface magnetic flux density) at the outer circumference of the rotor 1 is positive at the magnet magnetic pole P1 and negative at the virtual magnetic pole P2. The surface magnetic flux density crosses zero at a position corresponding to the flux barrier 12. The reason why the surface magnetic flux density decreases at the pole center of each of the magnet magnetic pole P1 and the virtual magnetic pole P2 is that the magnetic flux spreads symmetrically with respect to the corresponding magnetic pole center line (see FIG. 6).

As described above, the magnet magnetic poles P1 have the permanent magnets 20, while the virtual magnetic poles P2 have no permanent magnets. Thus, the surface magnetic flux density at the virtual magnetic pole P2 is lower than the surface magnetic flux density at the magnet magnetic pole P1.

The surface magnetic flux density at the virtual magnetic pole P2 is lower than that of the magnet magnetic pole P1, which causes vibration and noise of the rotor 1. This is because of the following reason. The magnetic attractive force acting between the virtual magnetic pole P2 and the tooth 52 is smaller than the magnetic attractive force acting between the magnet magnetic pole P1 and the tooth 52. This results in an imbalance in the force applied to the rotor 1 in the radial direction, and causes an excitation force acting on the rotor 1 in the radial direction.

When the rotor 1 rotates, the force in the circumferential direction applied to the magnet magnetic pole P1 from the front tooth 52 and the rear tooth 52 in the rotating direction is different from the force in the circumferential direction applied to the virtual magnetic pole P2 from the front tooth 52 and the rear tooth 52 in the rotating direction. This leads to an imbalance in the force in the circumferential direction applied to the rotor 1, causing a torque ripple in the rotor 1.

Thus, as the surface magnetic flux density at the virtual magnetic pole P2 decreases as compared to that at the magnet magnetic pole P1, the excitation force in the radial direction acting on the rotor 1 and the torque ripple increase, and cause vibration and noise.

As described above with reference to FIG. 4, the concentration of the magnetic flux onto the virtual magnetic pole P2 is promoted by narrowing the width W2 of the virtual magnetic pole P2 as compared to the width W1 of the permanent magnet 20, and thus the surface magnetic flux density at the virtual magnetic pole P2 increases. Thus, the excitation force in the radial direction and the torque ripple described above can be reduced, and vibration and noise can be reduced.

Next, the function of the slit 13 will be described. Even when the width W2 of the virtual magnetic pole P2 is set narrower than the width W1 of the permanent magnet 20 as described above, the magnetic flux density at the virtual magnetic pole P2 does not reach the magnetic flux density at the magnet magnetic pole P1, and thus the magnetic flux passing through the virtual magnetic pole P2 tends to be curved in the circumferential direction as described below.

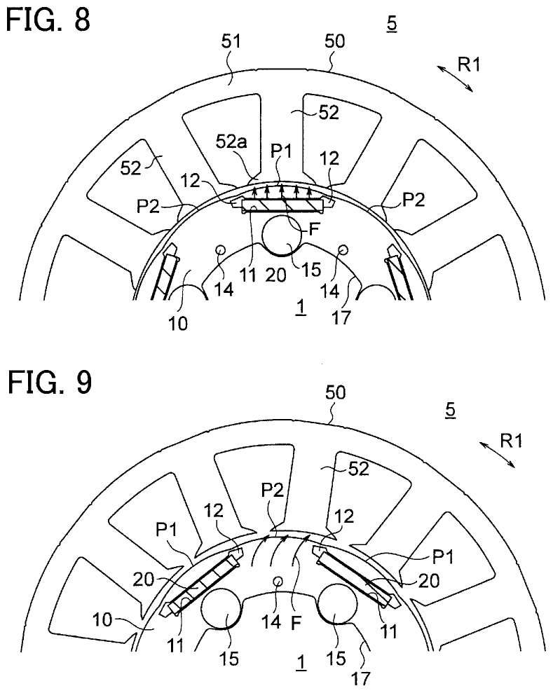

FIG. 8 is a schematic diagram illustrating the flow of magnetic flux from the permanent magnet 20 at the magnet magnetic pole P1. In this example, the N pole is defined as the outer side of the permanent magnet 20 in the radial direction. As illustrated in FIG. 8, the magnetic flux density at the magnet magnetic poles P1 is high, and thus the magnetic flux exiting from the magnet magnetic pole P1 tends to proceed to the outer side in the radial direction as indicated with the arrows F.

FIG. 9 is a schematic diagram illustrating the flow of magnetic flux at the virtual magnetic pole P2 when no slit 13 is provided at the virtual magnetic pole P2. In this example, the N pole is defined as the inner side of the permanent magnet 20 in the radial direction. Thus, the magnetic flux flows from the inner side in the radial direction toward the outer side in the radial direction at the virtual magnetic pole P2.

However, because the magnetic flux density at the virtual magnetic pole P2 is low, the magnetic flux flowing through the virtual magnetic pole P2 tends to be curved in the circumferential direction as indicated with the arrows F depending on the position of the tooth 52 facing the virtual magnetic pole P2. When the magnetic flux is curved as above, the excitation force in the radial direction and the torque ripple described above increase, and cause vibration and noise.

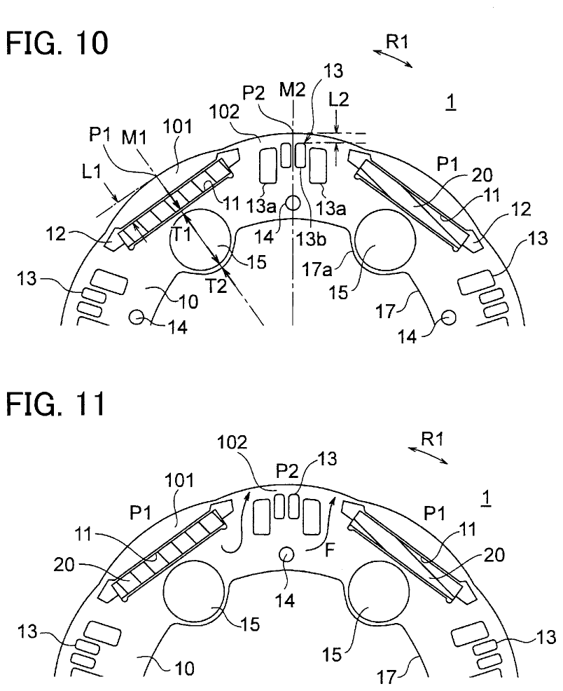

FIG. 10 is a schematic diagram illustrating the arrangement of the slits 13 at the virtual magnetic pole P2 of the first embodiment. As described above, the rotor core 10 of the first embodiment has at least one slit 13 at the virtual magnetic pole P2. The distance L1 from the magnet insertion hole 11 at the pole center to the outer circumference 16 of the rotor core 10 is longer than the shortest distance L2 from the slit 13 to the outer circumference 16 of the rotor core 10.

A core area 101 through which the magnetic flux flows is formed between the magnet insertion hole 11 at the magnet magnetic pole P1 and the outer circumference 16 of the rotor core 10. A core area 102 through which the magnetic flux flows is formed between the slits 13 at the virtual magnetic pole P2 and the outer circumference 16 of the rotor core 10.

FIG. 11 is a schematic diagram for explaining the function of the slits 13 at the virtual magnetic pole P2 in the first embodiment. The magnetic flux flowing through the virtual magnetic pole P2 tends to be curved in the circumferential direction depending on the position of the tooth 52 (FIG. 9) facing the virtual magnetic pole P2.

However, since the slits 13 are formed at the virtual magnetic pole P2, the curvature of the magnetic flux in the circumferential direction can be suppressed, and the flow direction of the magnetic flux can be made closer to the radial direction. In other words, the flow of magnetic flux at the virtual magnetic pole P2 can be rectified. Thus, a difference in the surface magnetic flux density between the magnet magnetic pole P1 and the virtual magnetic pole P2 can be reduced, and vibration and noise can be reduced as described above.

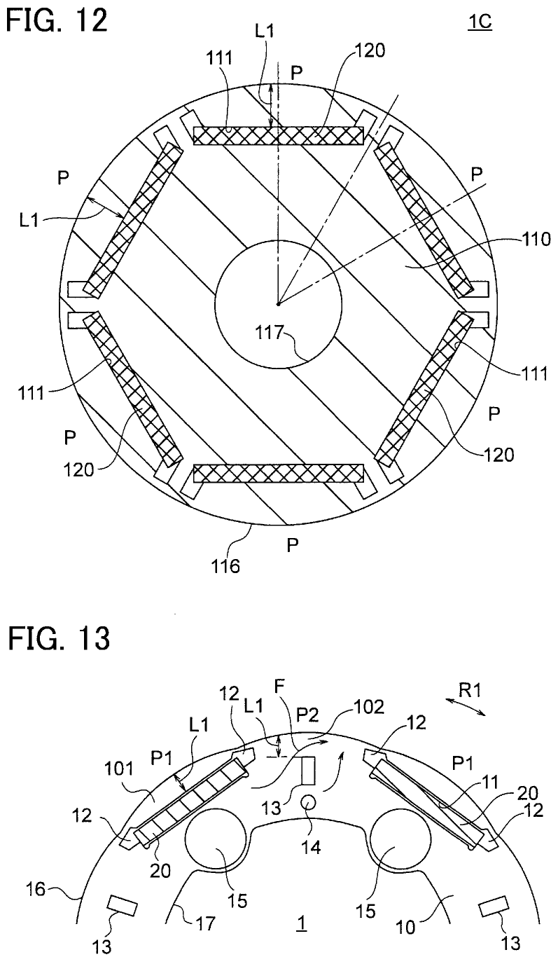

FIG. 12 is a sectional view illustrating a non-consequent pole rotor 1C. The rotor 1C includes a rotor core 110 having magnet insertion holes 111 and permanent magnets 120 inserted in the magnet insertion holes 111. A shaft (not shown) is inserted in a center hole 117 of the rotor core 110. The adjacent permanent magnets 120 have opposite magnetic pole surfaces on the outer sides in the radial direction. That is, all of the magnetic poles of the rotor 1C are formed by the magnet magnetic poles P. The distance L1 from the magnet insertion hole 111 to the outer circumference 116 of the rotor core 110 is the same for all of the magnetic poles.

FIG. 13 illustrates a configuration example in which the shortest distance from the slit 13 to the outer circumference 16 is the same as the distance L1 from the magnet insertion hole 11 at the pole center to the outer circumference 16 in the consequent pole rotor. In this regard, one slit 13 is illustrated for each virtual magnetic pole P2.

In the configuration example illustrated in FIG. 13, the core area 102 on the outer side of the slit 13 in the radial direction is wide because the shortest distance from the slit 13 to the outer circumference 16 is the same as the distance L1 from the magnet insertion hole 11 at the pole center to the outer circumference 16. Thus, the magnetic flux exiting from the permanent magnet 20 tends to flow through the core area 102 of the virtual magnetic pole P2 in the circumferential direction as indicated by the arrow F.

In contrast, in the first embodiment, the shortest distance L2 from the slit 13 to the outer circumference 16 of the rotor core 10 is shorter than the distance L1 from the magnet insertion hole 11 at the pole center to the outer circumference 16 of the rotor core 10. Thus, as illustrated in FIG. 11, the core area 102 on the outer side of the slit 13 in the radial direction is made narrower, and thus the magnetic flux is less likely to flow through the core area 102 in the circumferential direction. Therefore, the effect of making the flow direction of magnetic flux in the virtual magnetic pole P2 closer to the radial direction, i.e., the effect of rectifying the flow of the magnetic flux, can be enhanced.

From the viewpoint of enhancing the effect of rectifying the flow of magnetic flux, the shortest distance L2 from the slit 13 to the outer circumference 16 is desirably as short as possible. However, it is difficult to reduce the distance L2 to less than the sheet thickness of each electromagnetic steel sheet for manufacturing reasons. Thus, the lower limit of the distance L2 is the sheet thickness of each electromagnetic steel sheet of the rotor core 10.

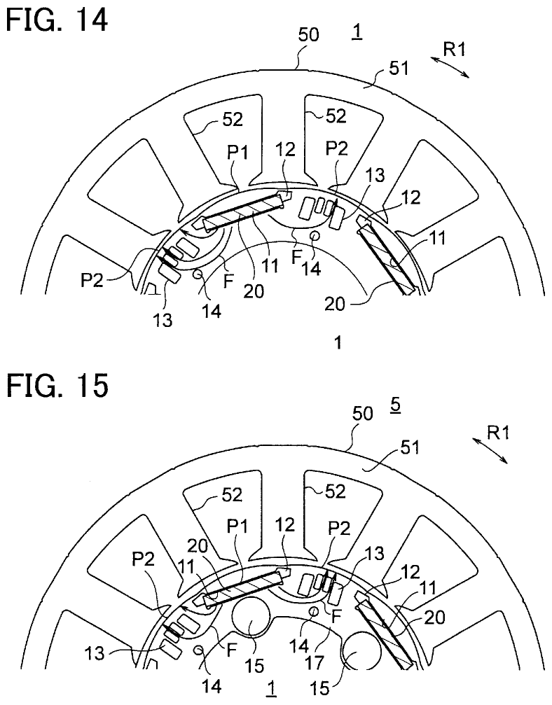

Next, the function of the opening portion 15 will be described. FIG. 14 is a schematic diagram illustrating the flow of magnetic flux when no opening portion 15 is formed on the inner side of the magnet insertion hole 11 in the radial direction. The magnetic flux exiting from the inner side of the permanent magnet 20 at the magnet magnetic pole P1 in the radial direction flows to the teeth 52 through the two virtual magnetic poles P2 on both sides thereof in the circumferential direction.

At this time, when an area of one virtual magnetic pole P2 facing the tooth 52 is larger than an area of the other virtual magnetic pole P2 facing the corresponding tooth 52, more magnetic flux tends to flow to the virtual magnetic pole P2 whose area facing the tooth 52 is larger. Such an imbalance in the magnetic flux can cause vibration and noise.

As illustrated in FIG. 15, in the first embodiment, the opening portion 15 is formed on the inner side of the magnet insertion hole 11 in the radial direction. The magnetic flux exiting from the inner side of the permanent magnet 20 in the radial direction is divided evenly into both sides of the permanent magnet 20 in the circumferential direction by the opening portion 15. Thus, the magnetic flux exiting from the permanent magnet 20 flows evenly in the circumferential direction, regardless of the position of the tooth 52.

In order to enhance the effect of evenly dividing the magnetic flux exiting from the permanent magnet 20, the opening portion 15 is desirably located on the magnetic pole center line M1.

In order to further enhance the effect of evenly dividing the magnetic flux exiting from the permanent magnet 20, it is more desirable to make an interval T1 between the opening portion 15 and the magnet insertion hole 11 and an interval T2 between the opening portion 15 and the inner circumference 17 both narrower. However, it is difficult to set each of the intervals T1 and T2 to be less than the sheet thickness of the electromagnetic steel sheet for manufacturing reasons. Thus, the lower limit of each of the intervals T1 and T2 is the sheet thickness of the electromagnetic steel sheet.

The division of the magnetic flux exiting from the inner side of the permanent magnet 20 in the radial direction has been described herein. In this regard, when the inner side of the permanent magnet 20 in the radial direction is the S pole, the magnetic flux flowing from both sides of the permanent magnet 20 in the circumferential direction flows into the permanent magnet 20 evenly in the circumferential direction by the opening portion 15. That is, the opening portion 15 makes it possible to suppress the imbalance in the magnetic flux exiting from the permanent magnet 20 and the imbalance in the magnetic flux flowing into the permanent magnet 20.

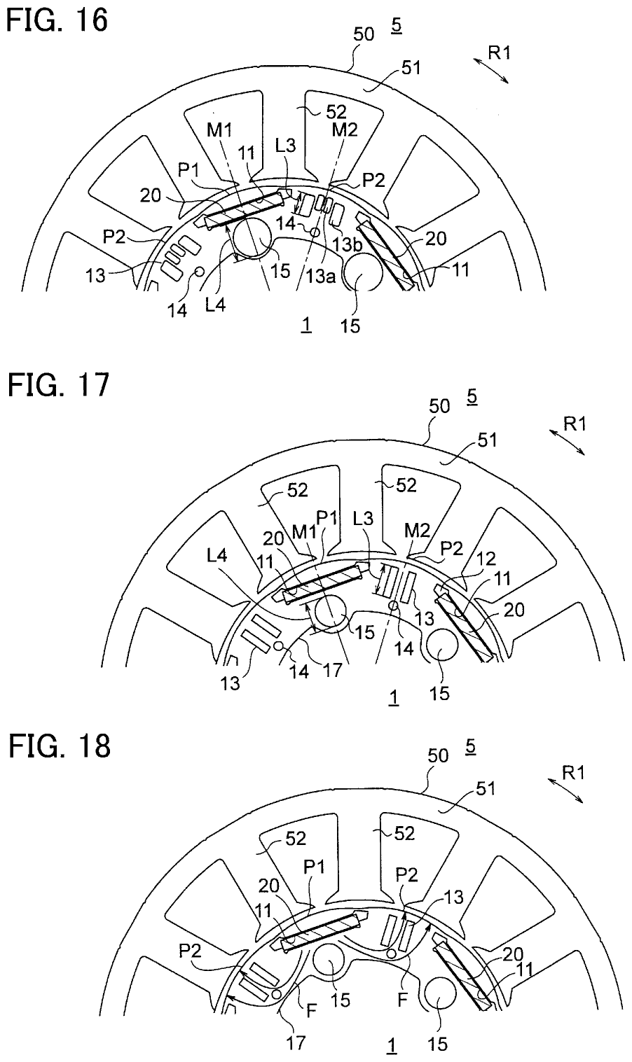

FIG. 16 is a schematic diagram for explaining the lengths of the slit 13 and the opening portion 15 in the radial direction, in the rotor core 10. The slit 13 has the maximum length L3 in the radial direction. In this example, the slit 13b is longer than the slit 13a, and thus the maximum length L3 is defined as the length of the slit 13b in the radial direction.

The opening portion 15 has the maximum length L4 in the radial direction. Since the opening portion 15 is circular in this example, the maximum length L4 of the opening portion 15 is a diameter of the opening portion 15. The maximum length L3 of the slit 13 is shorter than the maximum length L4 of the opening portion 15.

FIG. 17 is a schematic diagram illustrating an example in which the maximum length L3 of the slit 13 in the radial direction is longer than the maximum length L4 of the opening portion 15 in the radial direction. As illustrated in FIG. 17, when the maximum length L3 of the slit 13 in the radial direction is made longer than the maximum length L4 of the opening portion 15 in the radial direction, the slit 13 is extended inward in the radial direction.

Thus, as illustrated in FIG. 18, a magnetic path along which the magnetic flux exiting from the permanent magnet 20 passes through the virtual magnetic pole P2 and proceeds to the tooth 52 is increased in length. The increase in length of the magnetic path in the rotor core 10 leads to an increase in iron loss, and may cause a reduction in the motor efficiency.

In contrast, as illustrated in FIG. 16, when the maximum length L3 of the slit 13 in the radial direction is shorter than the maximum length L4 of the opening portion 15 in the radial direction, the magnetic path from the permanent magnet 20 to the tooth 52 through the virtual magnetic pole P2 can be shortened, and thus an increase in iron loss can be suppressed.

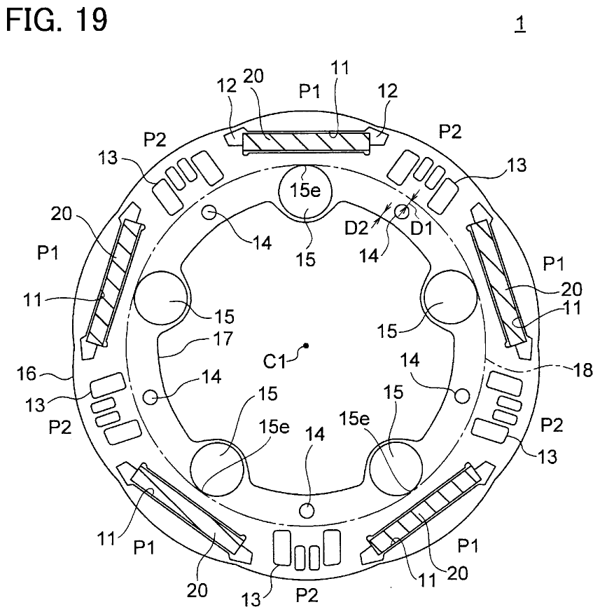

Next, the effect exhibited by the arrangement of the crimping portions 14 will be described. FIG. 19 is a schematic diagram for explaining the arrangement of the crimping portions 14 in the rotor core 10. A plurality of electromagnetic steel sheets constituting the rotor core 10 are integrally fixed together by the crimping portions 14 as described above.

Each crimping portion 14 is formed by pressing a crimping metal fitting against the surface of the electromagnetic steel sheet. When the electromagnetic steel sheet is applied with stress, its magnetic properties changes, and iron loss increases. Thus, when the crimping portions 14 are formed in the magnetic path, the iron loss may increase.

For this reason, in the first embodiment, the crimping portions 14 are disposed inside a circle 18 (virtual circle) that connects outer ends 15e of the opening portions 15 in the radial direction as illustrated in FIG. 19.

The magnetic flux exiting from the permanent magnet 20 at the magnet magnetic pole P1 is divided into both sides of the permanent magnet 20 in the circumferential direction by the opening portion 15 and then directed toward the virtual magnetic pole P2. Therefore, the amount of magnetic flux flowing through an area inside the circle 18 defined by the outer ends 15e of the opening portions 15 in the radial direction is small.

Thus, the amount of magnetic flux passing through the crimping portions 14 decreases, when the crimping portions 14 are disposed in the area inside the circle 18. That is, an increase in iron loss due to the flow of the magnetic flux through the crimping portions 14 can be suppressed.

As the crimping portion 14 is formed closer to the inner circumference 17, the magnetic flux passing through the crimping portion 14 decreases, and thus the effect of suppressing an increase in iron loss can be enhanced. Therefore, it is desirable that a distance D2 between the crimping portion 14 and the inner circumference 17 is shorter than a distance D1 between the crimping portion 14 and the circle 18.

Although the crimping portions 14 are formed on the inner side of the virtual magnetic poles P2 in the radial direction as illustrated in FIG. 19, the crimping portions 14 may be formed at any other positions inside the circle 18. The crimping portion 14 is a circular crimping portion as illustrated in FIG. 19, but it may be a V-shaped crimping portion (FIG. 21) or a crimping portion having any other shape.

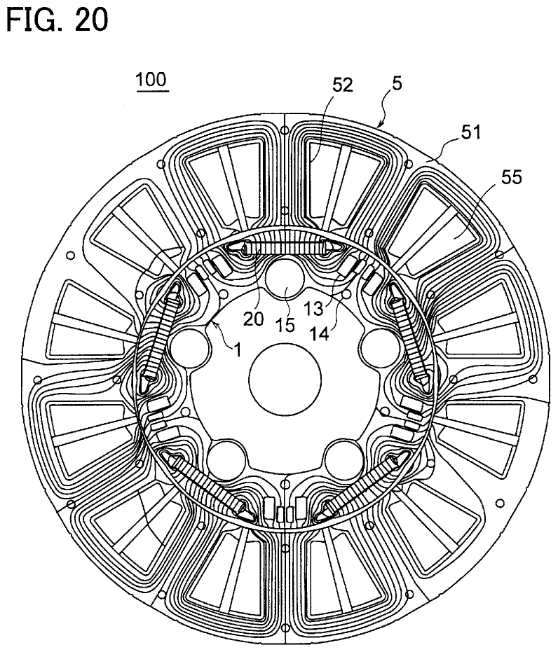

FIG. 20 is a magnetic flux diagram illustrating simulation results of the flow of magnetic flux in the motor 100 of the first embodiment. In FIG. 20, it is understood that the magnetic flux flowing through the virtual magnetic pole P2 is about to be curved in the circumferential direction depending on the position of the tooth 52, but is rectified by the slits 13 so that the flow of the magnetic flux is made closer to the radial direction.

It is also understood that the flow of the magnetic flux in the circumferential direction in the virtual magnetic pole P2 is suppressed because the shortest distance L2 from the slit 13 to the outer circumference 16 is shorter than the distance L1 from the magnet insertion hole 11 at the pole center to the outer circumference 16.

Furthermore, it is understood that the magnetic flux exiting from the permanent magnet 20 is divided evenly in the circumferential direction by the opening portion 15, and thus an imbalance in the magnetic flux can be suppressed. Moreover, it is understood that the amount of magnetic flux passing through the crimping portion 14 is small.

Next, the function of the resin portion 30 will be described. In the consequent pole rotor 1, the magnetic flux passing through the virtual magnetic pole P2 tends to flow to the shaft 25.

That is, in the non-consequent pole rotor 1C (FIG. 12), the permanent magnet 20 having the N pole on its inner side in the radial direction and the permanent magnet 20 having the S pole on its inner side in the radial direction are adjacent to each other in the circumferential direction, so that the magnetic flux exiting from the N pole of one permanent magnet 20 flows to the S pole of its adjacent permanent magnet 20.

In contrast, in the consequent pole rotor 1, the inner sides of all permanent magnets 20 in the radial direction have the same magnetic poles, for example, N poles. Consequently, the magnetic flux exiting from the N pole on the inner side of the permanent magnet 20 in the radial direction does not only tend to flow to the virtual magnetic pole P2, but also tend to flow toward the center of the rotor core 10. Such magnetic flux flows into the shaft 25 fixed to the center of the rotor core 10 and becomes a leakage flux.

For this purpose, in the first embodiment, the non-magnetic resin portion 30 is provided between the rotor core 10 and the shaft 25. By interposing the non-magnetic resin portion 30 between the rotor core 10 and the shaft 25, the magnetic flux is prevented from flowing from the rotor core 10 into the shaft 25, and thus the leakage flux can be reduced.

### Effects of Embodiment

As described above, the rotor 1 of the first embodiment includes the rotor core 10 having the magnet insertion holes and the permanent magnets 20 disposed in the magnet insertion holes 11. The permanent magnets 20 constitute the magnet magnetic poles P1, and parts of the rotor core 10 constitute the virtual magnetic poles P2. The width W2 of the virtual magnetic pole P2 in the circumferential direction is narrower than the width W1 of the permanent magnet 20 in the circumferential direction, and at least one slit 13 is formed at the virtual magnetic pole P2.

By narrowing the width W2 of the virtual magnetic pole P2 as compared to the width W1 of the permanent magnet 20, the magnetic flux can be concentrated onto the virtual magnetic pole P2, and thus the magnetic flux density at the virtual magnetic pole P2 can be increased. Further, the direction of the magnetic flux flowing through the virtual magnetic pole P2 can be made closer to the radial direction by the slit 13 provided at the virtual magnetic pole P2, and thus it is possible to reduce an imbalance in the magnetic flux between the magnet magnetic pole P1 and the virtual magnetic pole P2. As a result, vibration and noise can be reduced.

The shortest distance L2 from the slit 13 to the outer circumference 16 of the rotor core 10 is shorter than the distance L1 from the center of the magnet insertion hole 11 in the circumferential direction to the outer circumference 16 of the rotor core 10. Thus, the effect of making the direction of the magnetic flux flowing through the virtual magnetic pole P2 closer to the radial direction can be further enhanced, and the effect of reducing vibration and noise can be enhanced.

Since the opening portion 15 is formed on the inner side of the magnet insertion hole 11 in the radial direction, the imbalance in the magnetic flux exiting from the permanent magnet 20 and the imbalance in the magnetic flux flowing into the permanent magnet 20 can be suppressed, and thus the effect of reducing vibration and noise can be further enhanced.

When the maximum length L3 of the slit 13 in the radial direction is shorter than the maximum length L4 of the opening portion 15 in the radial direction, the magnetic path passing through the virtual magnetic pole P2 can be shortened, and thus an increase in iron loss can be suppressed.

The crimping portion 14 is formed inside the circle 18 passing through the outer ends 15e of the opening portions 15 in the radial direction, and thus an increase in iron loss due to the flow of magnetic flux through the crimping portion 14 can be suppressed.

The effect of making the direction of the magnetic flux flowing through the virtual magnetic pole P2 closer to the radial direction can be enhanced because the slit 13 extends in the radial direction. In addition, the effect of making the direction of the magnetic flux flowing through the virtual magnetic pole P2 closer to the radial direction can be further enhanced because a plurality of slits 13a and 13b are formed symmetrically with respect to the magnetic pole center line M2.

Since the non-magnetic resin portion 30 is provided between the rotor core 10 and the shaft 25, the leakage flux from the rotor core 10 to the shaft 25, which is specific to the consequent pole rotor, can be suppressed effectively.

### Second Embodiment

Next, a second embodiment will be described. FIG. 21 is a sectional view illustrating a rotor core 10A and the permanent magnets 20 in a rotor 1A of the second embodiment. The rotor 1A of the second embodiment differs from the rotor 1 of the first embodiment in the shapes and arrangement of the slits 13, opening portions 15A, and crimping portions 14A in the rotor core 10A.

In the second embodiment, two slits 13 elongated in the radial direction are formed at each virtual magnetic pole P2. The two slits 13 have the same shapes as each other and are disposed on both sides of the magnetic pole center line M2 in the circumferential direction and at equal distances from the magnetic pole center line M2. The number of slits 13 at each virtual magnetic pole P2 is not limited to two, but may be one (FIG. 22) or three or more.

The opening portion 15A formed on the inner side of the magnet insertion hole 11 in the radial direction has a slit shape elongated in the radial direction. The opening portion 15A is desirably formed on the magnetic pole center line M1.

The crimping portions 14A are formed inside the circle 18 that connects outer ends of the opening portions 15A in the radial direction. Each crimping portion 14A is a V-shaped crimping portion. The V-shaped crimping portion is formed by pressing a V-shaped crimping metal fitting against the surface of the electromagnetic steel sheet. Thus, the crimping portion 14A has a rectangular shape in a plane orthogonal to the axial direction.

The crimping portion 14A is desirably formed on the magnetic pole center line M2 of the virtual magnetic pole P2 in such a manner that its longitudinal direction coincides with the radial direction. This is because, by arranging the crimping portion 14A in this manner, the amount of magnetic flux passing through the crimping portion 14A decreases the most (see FIG. 20), and an increase in iron loss can be effectively suppressed.

Each of the outer and inner circumferences 16 and 17 of the rotor core 10A has a circular shape about the axis C1. In this regard, the outer circumference 16 may be a flower shape (FIG. 4), like the outer circumference 16 of the rotor core 10 of the first embodiment. The inner circumference 17 may have the protruding portion 17a (FIG. 4), like the inner circumference 17 of the rotor core 10 of the first embodiment.

FIG. 22 is a schematic diagram for explaining the arrangement of the slits 13, the opening portions 15A, and the crimping portions 14A of the second embodiment. The shortest distance L2 from the slit 13 to the outer circumference 16 of the rotor core 10A is shorter than the distance L1 from the magnet insertion hole 11 at the pole center to the outer circumference 16 of the rotor core 10A. The maximum length L3 of the slit 13 in the radial direction is shorter than the maximum length L4 of the opening portion 15A in the radial direction.

The rotor 1A of the second embodiment is configured in a similar manner to the rotor 1 of the first embodiment except for the shapes and arrangement of the slits 13, the opening portions 15A, and the crimping portions 14A.

Also in the rotor 1A of the second embodiment, the slits 13 are formed at the virtual magnetic poles P2, so that the direction of the magnetic flux flowing through the virtual magnetic pole P2 can be made closer to the radial direction. Thus, an imbalance in the magnetic flux at the magnet magnetic pole P1 and an imbalance in the magnetic flux at the virtual magnetic pole P2 can be reduced, and thus vibration and noise can be reduced.

The shortest distance L2 from the slit 13 to the outer circumference 16 of the rotor core 10A is shorter than the distance L1 from the magnet insertion hole 11 at the pole center to the outer circumference 16 of the rotor core 10A. Thus, the magnetic flux is less likely to flow in the circumferential direction at the virtual magnetic pole P2, and the effect of reducing vibration and noise can be further enhanced.

The opening portion 15A is formed on the inner side of the magnet insertion hole 11 in the radial direction, and thus the magnetic flux exiting from the permanent magnet 20 flows evenly in the circumferential direction. Thus, an imbalance in the magnetic flux can be suppressed, and the effect of reducing vibration and noise can be further enhanced.

In this regard, a part of the rotor 1A of the second embodiment may be combined with the rotor 1 of the first embodiment. For example, the rotor 1 of the first embodiment may be provided with the slit-shaped opening portion 15A of the rotor 1A of the second embodiment, instead of the circular opening portion 15. The rotor 1 of the first embodiment may be provided with the crimping portion 14A (V-shaped crimping portion) of the rotor 1A of the second embodiment, instead of the crimping portion 14 (circular crimping portion).

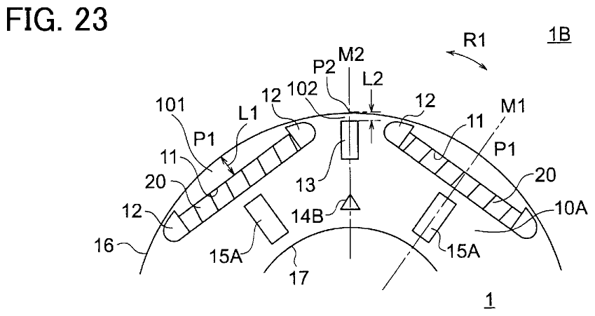

As illustrated in FIG. 23, a crimping portion 14B having a triangle shape in a plane orthogonal to the axial direction may be formed inside the circle 18 (FIG. 21) of the rotor core 10A. The arrangement of the crimping portions 14B illustrated in FIG. 23 is the same as that of the crimping portions 14A illustrated in FIGS. 21 and 22.

### (Air Conditioner)

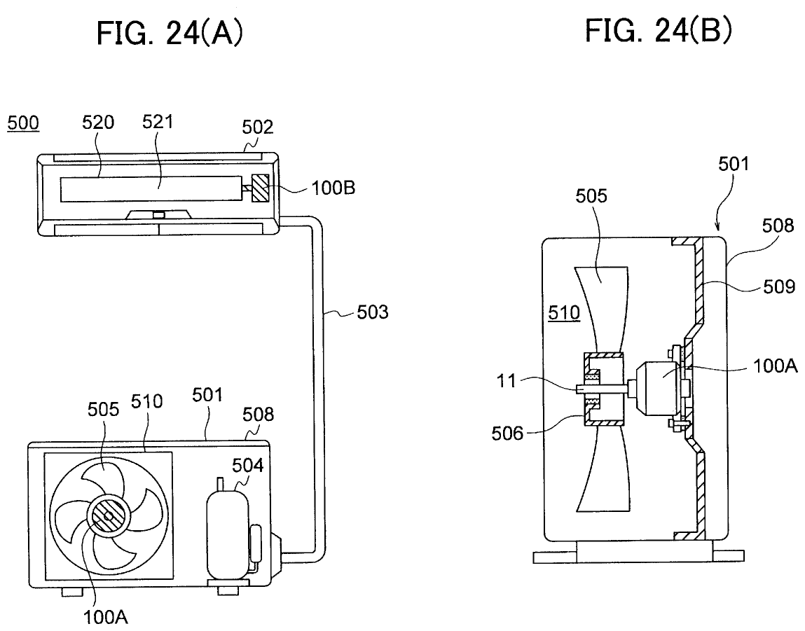

Next, an air conditioner to which the motor of each of the above described embodiments is applied will be described. FIG. 24(A) is a diagram illustrating the configuration of an air conditioner 500 to which the motor 100 of the first embodiment is applied. The air conditioner 500 includes an outdoor unit 501, an indoor unit 502, and a refrigerant pipe 503 connecting these units 501 and 502.

The outdoor unit 501 includes an outdoor fan 510 which is, for example, a propeller fan. The indoor unit 502 includes an indoor fan 520 which is, for example, a cross flow fan. The outdoor fan 510 has an impeller 505 and a motor 100A for driving the impeller 505.

The indoor fan 520 has an impeller 521 and a motor 100B for driving the impeller 521. Each of the motors 100A and 100B is constituted by the motor 100 described in the first embodiment. FIG. 24(A) also illustrates a compressor 504 to compress a refrigerant.

FIG. 24(B) is a sectional view of the outdoor unit 501. The motor 100A is supported by a frame 509 disposed in a housing 508 of the outdoor unit 501. The impeller 505 is attached to the shaft 25 of the motor 100A via a hub 506.

In the outdoor fan 510, the rotation of the rotor 1 of the motor 100A rotates the impeller 505 to blow air to a heat exchanger (not shown). During a cooling operation of the air conditioner 500, heat is released when the refrigerant compressed by the compressor 504 is condensed in the heat exchanger (condenser), and this heat is released to the outside of a room by air blown by the outdoor fan 510.

In the indoor fan 520 (FIG. 24(A)), the rotation of the rotor 1 of the motor 100B rotates the impeller 521 to blow air to the inside of the room. During the cooling operation of the air conditioner 500, the air whose heat is taken by the refrigerant when the refrigerant evaporates in an evaporator (not shown) is blown into the room by the indoor fan 520.

Since the motor 100 described in the above described first embodiment generates less vibration and noise, the quietness of the fans 510 and 520 can be improved. Thus, the quietness of the air conditioner 500 can be improved.

Although the motor 100 of the first embodiment is used as the motor 100A of the outdoor fan 510 and the motor 100B of the indoor fan 520 in this example, it is sufficient the motor 100 of the first embodiment is used as at least one of the motors 100A and 100B. Instead of the motor 100 of the first embodiment, a motor including the rotor 1A (FIG. 21) of the second embodiment may be used.

The motor 100 described in each of the first and second embodiments can also be mounted on any electric apparatuses other than the fan of the air conditioner.

Although the desirable embodiments of the present disclosure have been specifically described above, the present disclosure is not limited to the above embodiments, and various modifications and changes can be made to those embodiments without departing from the scope of the present disclosure.

1. A rotor comprising:
a rotor core having an outer circumference extending in a circumferential direction about an axis, the rotor core having a magnet insertion hole; and
a permanent magnet disposed in the magnet insertion hole,
wherein the permanent magnet constitutes a magnet magnetic pole, and a part of the rotor core constitutes a virtual magnetic pole,
wherein the rotor core has an opening portion on the axis side with respect to the magnet insertion hole,
wherein a width of the virtual magnetic pole in the circumferential direction is narrower than a width of the permanent magnet in the circumferential direction,
wherein the rotor core has at least one slit at the virtual magnetic pole, and
wherein a maximum length L3 of the at least one slit in a radial direction about the axis and a maximum length L4 of the opening portion in the radial direction satisfy L3<L4.

2. The rotor according to claim 1, wherein a distance L1 from a center of the magnet insertion hole in the circumferential direction to the outer circumference and a shortest distance L2 from the at least one slit to the outer circumference satisfy L1>L2.

3-4. (canceled)

5. The rotor according to claim 1, wherein the rotor core has a crimping portion, and
wherein the crimping portion is formed inside a circle about the axis, the circle passing through a farthest end of the opening portion from the axis.

6. The rotor according to claim 5, wherein a distance from the crimping portion to the circle is longer than a distance from the crimping portion to an inner circumference of the rotor core.

7. The rotor according to claim 1, wherein the opening portion has a circular shape or a slit shape.

8. The rotor according to claim 1, wherein the opening portion is located on a straight line that connects the axis and a center of the magnet insertion hole in the circumferential direction.

9. The rotor according to claim 1, wherein the at least one slit is elongated in a radial direction about the axis.

10. The rotor according to claim 9, wherein the at least one slit has a plurality of slits arranged symmetrically with respect to a straight line in the radial direction that passes through a center of the virtual magnetic pole in the circumferential direction.

11. The rotor according to claim 1, further comprising:
a shaft about the axis; and a non-magnetic resin portion provided between the shaft and the rotor core.

12. A motor comprising:
the rotor according to claim 1; and
a stator surrounding the rotor from outside in a radial direction about the axis.

13. A fan comprising:
the motor according to claim 12; and
an impeller rotated by the motor.

14. An air conditioner comprising an outdoor unit and an indoor unit connected to the outdoor unit via a refrigerant pipe,
wherein at least one of the outdoor unit and the indoor unit has the fan according to claim 13.
